(19) United States
(12) Patent Application Publication
(10) Pub. No.: US 2004/0019519 A1
(43) Pub. Date: Jan. 29, 2004

(54) Method of evaluating a service to be supplied and system using the same

(76) Inventors: Shigeyuki Tani, Sagamihara (JP); Chizuko Yasunobu, Tokyo (JP); Takashi Yabutani, Hitachinaka (JP); Hiroyuki Yagi, Tokorozawa (JP)

Correspondence Address: MATTINGLY, STANGER & MALUR, P.C., ATTORNEYS AT LAW, 1800 DIAGONAL ROAD, SUITE 370, ALEXANDRIA, VA, 22314, US

(21) Appl. No.: 10/397,186

(22) Filed: Mar. 27, 2003

(30) Foreign Application Priority Data
Apr. 5, 2002 (JP) 2002-103343

(51) Int. Cl. G06F 17/60

(52) U.S. Cl. 705/10

(57) ABSTRACT

An evaluating service system includes a random number generator for generating a random number for use in a simulation for predicting an operating rate of a facility, an operating rate simulation unit for predicting an operating rate, a device utilization effect calculation unit for calculating a device utilization effect from a predicted operating rate, a device utilization effect/income conversion unit for converting the device utilization effect to an income, an introduction/operation expense calculation unit for calculating costs generated by the introduction and operation of the device, a profit calculation unit for calculating a profit generated by the introduced device from the income and expense, a predicted profit storage unit for storing the result of at least two or more profit predictions, and a predicted profit display unit for displaying the result of an evaluation on a screen or printing the result for presentation.

### BACKGROUND OF THE INVENTION

1. Field of the Invention

The present invention relates to a method of evaluating a service effect of a service to be supplied between a service supply business entity and a load facility user which desire an effect by utilizing devices, and a method of supporting a contract of the service to be supplied, and more particularly, to a method of evaluating a service to be supplied associated with the methods, which is characterized by calculating a range or a distribution of a device utilization effect which can be expected for each predetermined period, for example, for each year or each month from an estimate of operation of a facility into which a device has been introduced, once converting the device utilization effect to an amount of money to calculate an income for each predetermined time, and calculating a profit for each predetermined period from expenditures required for the introduction and operation of a device supply service to present a profit range, an average value, a time-series graph and a distribution graph for each predetermined period.

2. Description of the Related Art

A service of supplying energy saving devices exists as an exemplary service of supplying devices. With an incentive given by the enforcement of the “law on streamlining of used energy (energy saving law)” in 1999 and the like, the energy saving strategy which had been conventionally directed to large scaled factories, has been extensively applied to small and medium-scaled factories. In response, as described in JP-A-2001-155083, JP-A-2001-155089, and JP-A-2001-155090, there have been provided energy saving support service methods for concluding a service utilization contract between an energy saving device service business entity and a load facility user which wishes energy saving to permit the load facility user to pay a service utilization fee from energy saving merits actually provided thereto. A method of diagnosing a device utilization effect, as shown in JP-A-2001-312523, calculates wasted energy when an energy saving device under diagnosis is not introduced from an energy efficiency of the introduced energy saving device, and a distribution of the introduced device and a group of data (devices) under similar conditions to diagnose the energy saving from the magnitude of the calculated energy.

However, in the device supply service method in which the service utilization fee is paid from the provided device utilization merits, the device supply service business entity is burdened with a risk when the device utilization effect is not so large, as compared with sales of the device to the load facility user, so that the device supply service business entity is increasingly requiring to evaluate and understand the risks of the device supply service provided by the device supply service business entity, but there has been no method available therefor. On the other hand, while the conventional device utilization effect (energy saving effect) diagnosis method diagnoses the device utilization effect from an energy efficiency distribution which is actually measured with an introduced device, no evaluation has been made on a risk of the overall service business such as costs generated in the introduction and operation of the device supply service, for example, device maintenance expenses, property tax and the like, or on a risk over a plurality of years after the introduction.

### SUMMARY OF THE INVENTION

It is an object of the present invention to provide a method and a system which permit a service supply entity and a user to understand risks and merits of a supplied service.

Thus, there is an aspect of the invention to provide by calculating a range or a distribution of a device utilization effect which can be expected for each predetermined period from a predicted operating rate using a model for predicting a range of an operating condition of a facility intended for introduction, converting the device utilization effect to an amount of money to calculate an income for each predetermined period, calculating expenses and income generated by the introduction and operation of a device supply service such as a device maintenance expense, property tax and the like to calculate a profit for each predetermined period, and displaying and/or printing characteristic values which define a range of the profit for each predetermined period, for example, a maximum value and an minimum value, and an average value, or displaying and/or printing a time-series graph which presents data side by side in the order of predetermined periods, thereby permitting a device supply service business entity to evaluate and understand risks and merits of the device supply service provided thereby in the future, while permitting a load facility user which wishes the device utilization effect to understand the risks and merits of introducing the device supply service to readily determine the introduction. In this way, it is possible to support a contract for the introduction of the device supply service between the device supply service business entity and load facility user.

Also, for a plurality of services such as device purchase and device lease, profits are calculated for each predetermined period in the same manner to display and/or print characteristic values which define ranges of profits, and average values, or time-series graphs for comparison, thereby permitting the load facility user to readily determine which of the device services should be introduced, while permitting the device supply service business entity to present the prepotency of the device supply service provided thereby.

Further, when there is a contract clause such as a cancellation or takeover of a device in the middle of a service, a profit is calculated for each predetermined period in the same manner to display for comparison the characteristic values which define the ranges of profits, and average values, or time-series graphs when the contract clause is included and when the contract clause is not included, thereby permitting the load facility user to understand the effect when the cancellation clause or takeover clause is included in the contract to readily determine whether or not the contract clause should be included upon introduction of the device supply service, while permitting the device supply service business entity to calculate the price of each contract clause for presentation.

The present invention is not limited to the device supply service, rental of objects, or the like.

Other objects, features and advantages of the present invention will become apparent from the following description of embodiments of the present invention taken in conjunction with the accompanying drawings.

### BRIEF DESCRIPTION OF THE DRAWINGS

FIG. 1 is a diagram illustrating a system according to the present invention;

FIG. 2 is a diagram illustrating a system in which risk factors other than an operating rate are added;

FIG. 3 is a table indicating predicted profits;

FIG. 4 is a time-series graph showing predicted profits;

FIG. 5 is a distribution graph showing a distribution of predicted profits;

FIG. 6 is a diagram illustrating a system for comparing a plurality of services;

FIG. 7 is a table indicating predicted profits of a plurality of services for comparison;

FIG. 8 is a distribution graph indicating predicted profits of a plurality of services for comparison;

FIG. 9 is a system diagram for comparing predicted profits between a service business entity and a load facility user;

FIG. 10 is a table for comparing predicted profits between the service business entity and load facility user;

FIG. 11 is a diagram for comparing profit distributions of the service business entity and load facility user;

FIG. 12 is a system diagram for calculating service fee upper and lower limit values;

FIG. 13 is a diagram showing a risk allowable range;

FIG. 14 is a table showing service fee upper and lower limit values;

FIGS. 15A and 15B are diagrams each showing a change in profit distribution by adding the service fee upper and lower limit values;

FIG. 16 is a diagram illustrating a device utilization effect (energy saving effect);

FIG. 17 is a diagram illustrating an operating rate model;

FIG. 18 is a diagram illustrating an implementation of the system according to the present invention;

FIG. 19 is a system diagram for calculating an option price; and

FIG. 20 is a diagram showing a change in profit distribution by adding a contract clause.

### DETAILED DESCRIPTION OF THE EMBODIMENTS

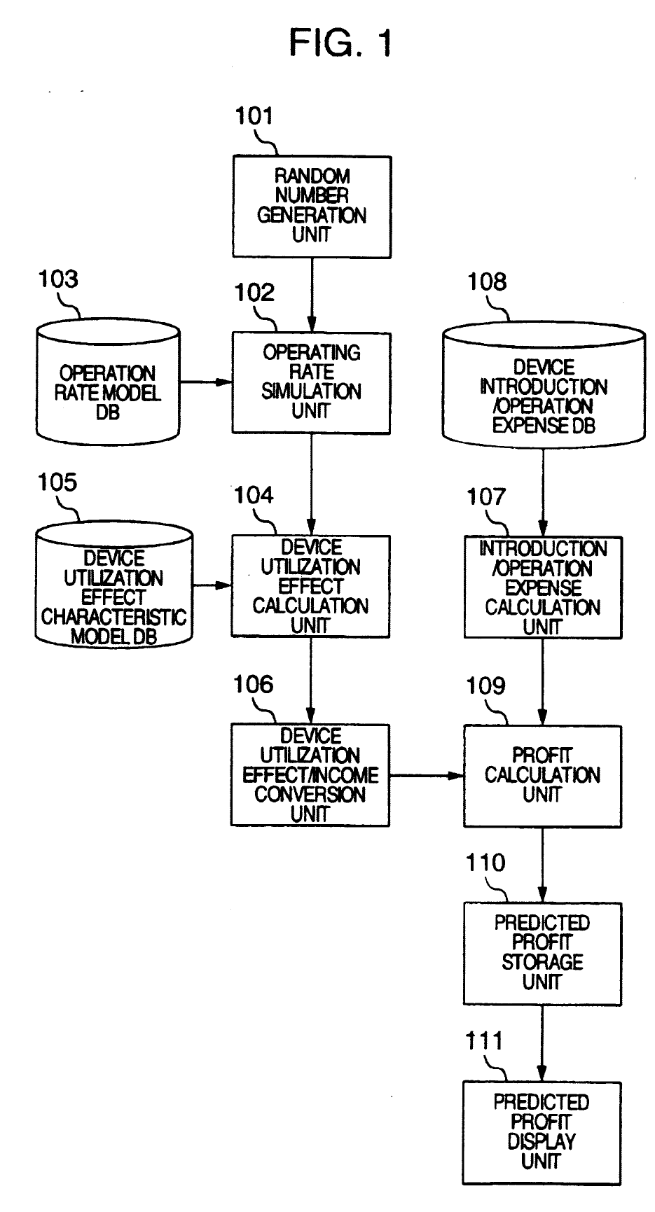

Embodiments of the present invention will be described with reference to FIGS. 1 to 20.

FIG. 1 is a system diagram of the present invention, wherein a device supply service evaluation method and a contract support method comprise a random number generation unit 101 for generating random numbers for use in an operating rate prediction simulation for a facility into which a device is introduced (hereinafter called the “load facility”); an operating rate simulation unit 102 for predicting the operating rate of the load facility; a device utilization effect calculation unit 104 for calculating a device introduction effect from a predicted operating rate; a device utilization effect/income conversion unit 106 for converting a device utilization effect to an income (amount of money); an introduction/operation expense calculation unit 107 for calculating a cost generated over a plurality of years associated with the introduction and operation of a device supply service; a profit calculation unit 109 for calculating a profit (including a loss) generated by the introduction of an energy saving device from the calculated income and expense; a predicted profit storage unit 110 for storing the results of a plurality of profit predictions (at least two); and a predicted profit display unit 111 for displaying and/or printing the result of an evaluation on the device supply service using the stored profit prediction results for presentation.

By using the methods, a device supply service business entity can evaluate and understand risks and merits in the future of the device supply service provided by itself, while the load facility user which wishes a device utilization effect can readily determine the introduction of the device provision service by understanding risks and merits resulting from the introduction.

### Embodiment 1

Embodiment 1 will be described on the assumption that a device to be supplied is an energy saving device, wherein, particularly, a load facility is a motor drive, and an energy saving device is an inverter. In Embodiment 1, the effect of the introduced energy saving device is predicted at regular time intervals from the current time, for example, every year to simulate accumulated profits for a predetermined period, for example, for eight years from the year of introduction in FIG. 4. In the simulation, the operating rate of the load facility is fluctuated using a random number every year as an indefinite element, and a plurality of times, for example, 1,000 times of simulations herein are repeated for the predetermined period to calculate a range which can be taken by the result of profit prediction, a maximum value and a minimum value of the prediction result, for example, on a year-by-year basis.

The processing in Embodiment 1 will be described based on the system diagram of FIG. 1.

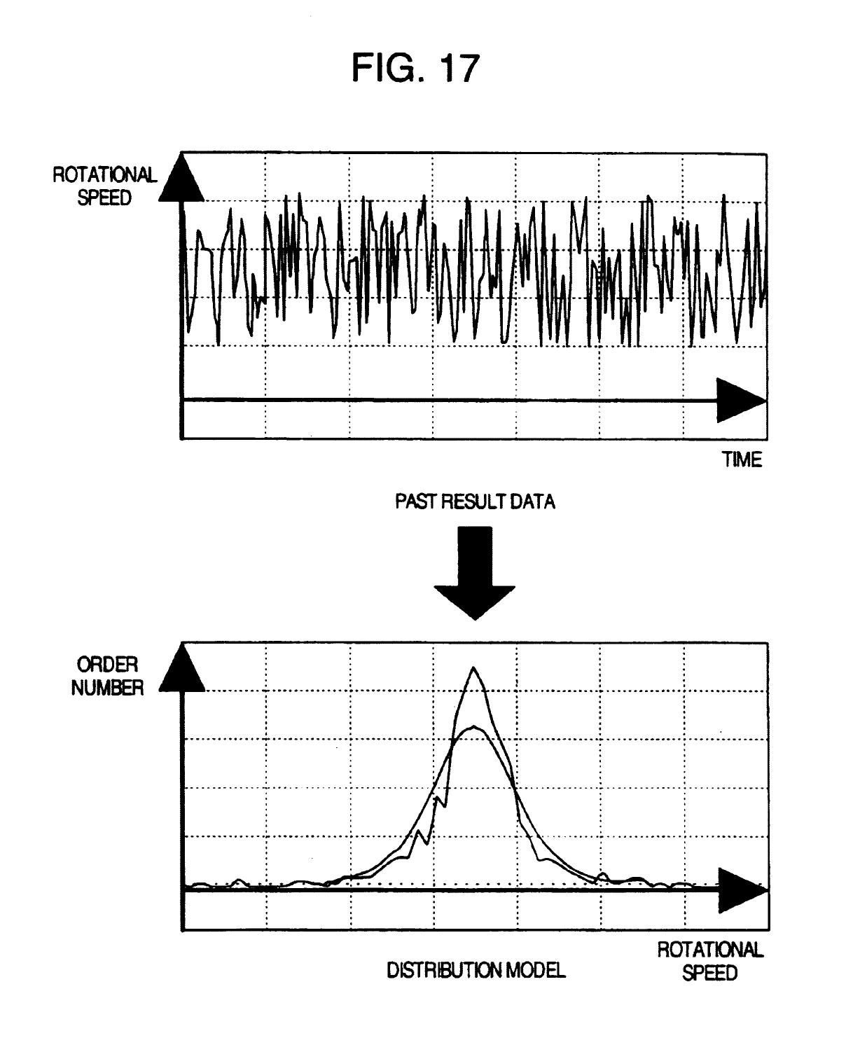

The random number generator 101 generates a random number R(k, i), where k represents the number of times of simulations, and i represents a predicted year in each simulation. The operating rate simulation unit 102 receives the random number R(k, i) generated by the random number generator 101, and determines an operating rate W(k, i) in an i-th year in a k-th simulation from a previously set operating rate prediction model of the load facility and the random number R(k, i). Here, the operating rate prediction model may be given as an arbitrary normal distribution model as indicated by Expression (1), or may be an operating rate model created by totalizing actual operating rate data of the load facility in the past several years, and building a distribution model, as illustrated in FIG. 17. These models are stored in the operating rate model database (DB) 103.

$$W ( k , i ) = \frac{1}{\sqrt{2 π σ}} {ⅇ}^{- {( R ( k , i ) - μ )}^{2} / 2 {σ}^{2}} \qquad ( 1 )$$

where μ represents the average value of the operating rate, σ a variance of the operating rate, which are set values appropriate for a particular load facility. Also, assuming herein that the load facility is a motor, and the operating rate is the rotational speed of the motor.

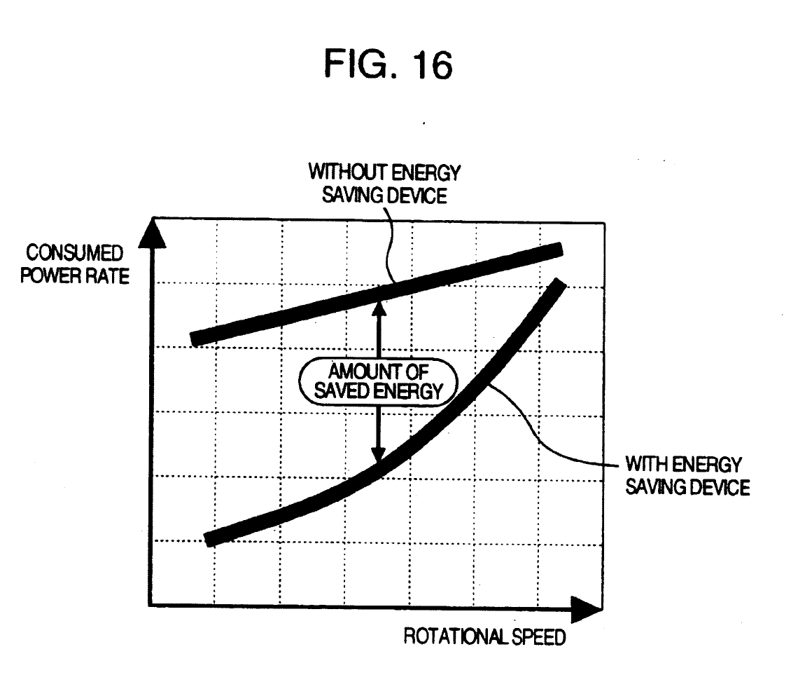

The device utilization effect calculation unit 104 calculates a device utilization effect (energy saving effect) P(k, i) using a device utilization effect (energy saving effect) model from the operating rate W(k, i) determined in the operating rate simulation unit 102. Assuming herein that the energy saving effect is the amount of power consumed by the motor, and the energy saving device is an inverter. As illustrated in FIG. 16, the energy saving effect model is a power consumption amount model of Expression (2) when the energy saving device is not introduced:

P1(k, i)=α·W(k, i)+b (2)

where a, b are values which are set appropriately for the motor of interest. Also, assuming herein that the energy saving device is an inverter, the power consumption amount model when the energy saving device introduced has been previously given to an energy saving device characteristic model of Expression (3) is DB 105:

P2(k, i)=α·(W(k, i))³+β (3)

where α, β are values which are set appropriately for the inverter of interest. A power consumption amount P1 and a power consumption amount P2 are calculated from the operating rate W(k, i), and an energy saving effect P(k, i)=P1−P2 is calculated from these values.

The device utilization effect/income conversion unit 106 calculates an income IN(k, i) resulting from the energy saving effect P(k, i) calculated in the device utilization effect calculation unit 104 and a device utilization effect (energy saving effect)/income conversion model. The energy saving effect/income conversion model is calculated herein from a unit power rate C as indicated by Expression (4):

IN(k, i)=C×P(k, i) (4)

It should be noted herein that as described in JP-A-2001-155083, for a mode of service in which a service utilization fee F(k, i) is paid from the actually provided energy saving merit, the service utilization fee F(k, i) is calculated from the income IN(k, i). For example, when the service utilization fee is determined to be a constant proportion PR of the actually provided device utilization (energy saving) merit, the service utilization fee F(k, i) is calculated as PR×IN(k, i). Also, the service utilization fee F(k, i) is an expense for the load facility user, but is an income for the device provision service business entity.

The introduction/operation expense calculation unit 107 calls a cost for a predetermined period required for the introduction and operation of the device from a device introduction/operation expense database (DB) 108 to calculate an year-by-year operation expense OUT(i). The device introduction/operation cost may be, herein, a maintenance device expense Mm(i), a maintenance labor cost Mh(i), a property tax T(i), a device lease expense L(i), and the like. With the service utilization fee F(k, i) added thereto, the year-by-year operation expense OUT(k, i) is calculated as shown in Expression (5):

OUT(k, i)=Mm(i)+Mh(i)+T(i)+L(i)+F(k, i) (5)

Also, it is contemplated herein that the property tax T(i) and device lease expense L(i) vary depending on the device introduction price. For example, the property tax T(i) is calculated from a depreciation B(A, i) determined by the device introduction price A.

The profit calculation unit 109 calculates a profit G(k, i) on a year-by-year basis from the IN(k, i) calculated in the device introduction effect/income conversion unit 106, and the operation expense OUT(k, i) calculated in the introduction/operation expense calculation unit 107 as indicated by Expression (6):

G(k, i)=IN(k, i)−OUT(k, i) (6)

and calculates an accumulated profit AG(k, i) in each year from the profits in the respective years as indicated by Expression (7):

AG(k, i)=AG(k, i−1)+G(k, i) (7)

The profit calculation unit 109 further discounts the year-by-year profit to a net current value to calculate a discount profit Gp(k, i) as indicated by Expression (8):

$$Gp ( k , i ) = \frac{G ( k , i )}{{( 1 + j )}^{i}} \qquad ( 8 )$$

In Expression (7), it is contemplated that the accumulated profit AG(k, i) is calculated by using the discount profit Gp(k, i) instead of the profit G(k, i). Also, here, expense items are indefinite depending on a service mode as follows: a device purchase cost is an expense for the load facility user in a purchase of a device, a device lease cost is an expense for the load facility user in a lease of a device, and the like.

The predicted profit storage unit 110 totalizes and stores profit prediction simulation result data {AG(k, i): k=1 to N} for predetermined number of times, with random numbers generated by repeating a predetermined times N in the random number generation unit 101. Also, simultaneously, the predicted profit storage unit 110 simultaneously calculates and stores a maximum value AGmax(i)=max{AG(k, i)}, a minimum value AGmin(i)=min{AG(k, i)} and an average value AGavg(i)=Σ{AG(k, i)}/N of the simulation result data {AG(k, i)}; k=1 to N} on a year-by-year basis, as characteristic values which define a range of the predicted profit. As a further characteristic value defining the range of the predicted profit, it is contemplated to calculate a width AGwid(i) between the maximum value AGmax(i) and minimum value AGmin(i) (AGwid(i)=Maximum AGmax(i)−Minimum AGmin(i)). Furthermore, it is contemplated to calculate a distribution of the predicted profit on a year-by-year basis to store distribution data. Here, as the distribution data in an i-th year, a range from the maximum value AGmax(i) to the minimum value AGmin(i) is divided, for example, into a predetermined number n, here into 100 (n=100), the number of predicted profit values included in a divided range Sp(i, m); m=1−n is counted, and a combination of the divided range Sp(i, m) and the count number CN (i, m) is stored as distribution data.

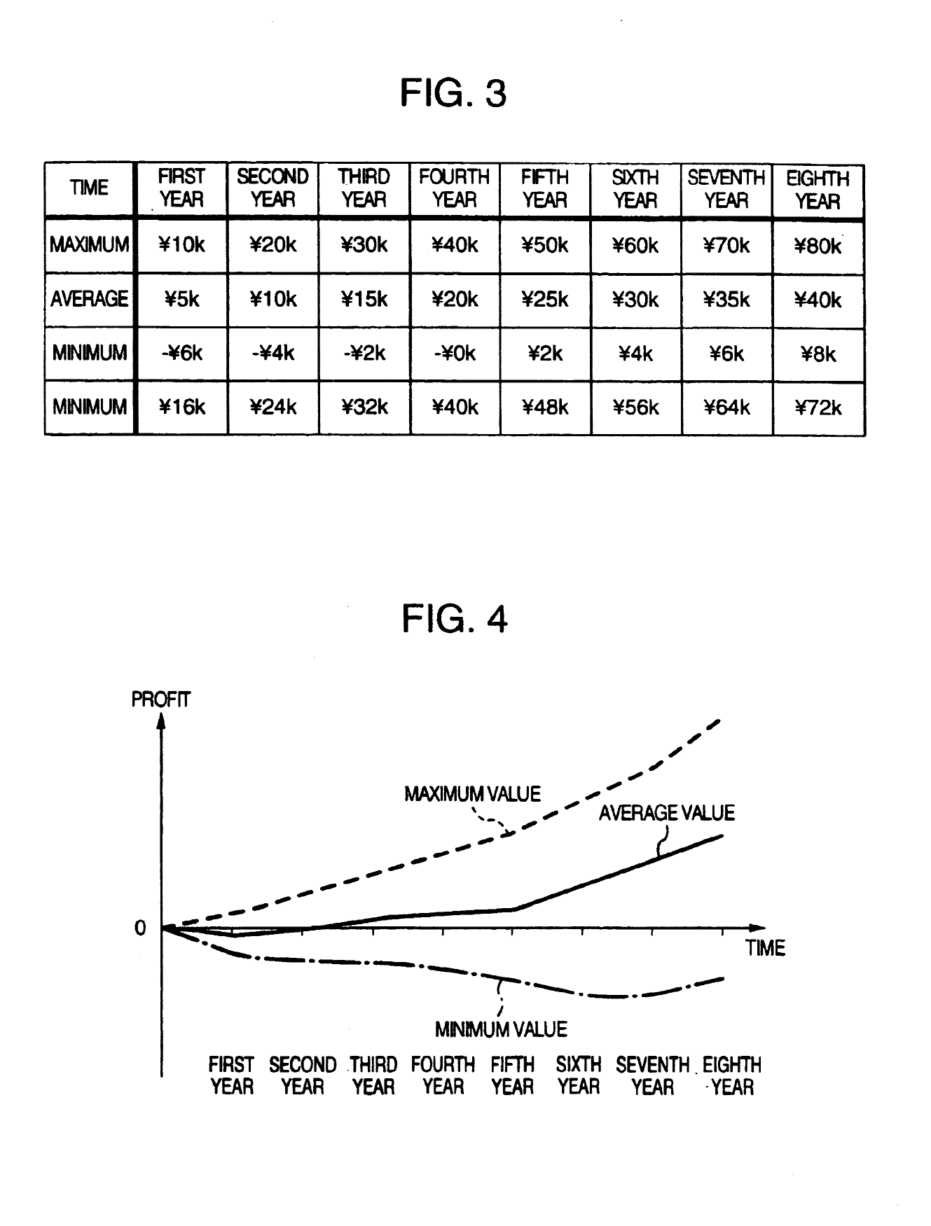

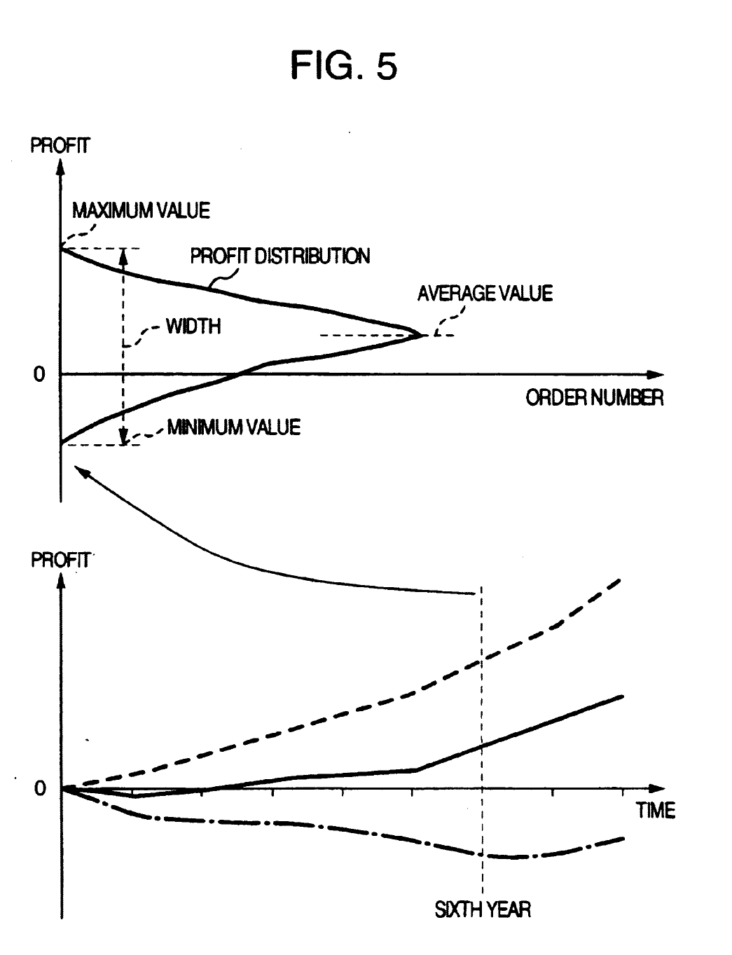

The predicted profit display unit 111 presents, as shown in FIG. 3, at least one or more values of the maximum value AGmax(i), minimum value AGmin(i), width AGwid(i) and average value AGavg(i) of the predicted profit in each year calculated in the predicted profit storage unit 110. The predicted profit display unit 111 also presents a time-series graph comprised of respective year-series as shown in FIG. 4. The term “display” used herein may be a representation on a display, a printed matter by a printer, or the like. It is also possible to display or print a distribution graph for an i-th year, as shown in FIG. 5, from the divided range Sp(i, m) and the distribution data of the count number CN(i, m). Here, the upper graph in FIG. 5 shows a distribution of the predicted profit simulation result in the sixth year.

In this way, Embodiment 1 can calculate a profit resulting from an expense caused by the introduction and operation of a device supply service and an income resulting from the device utilization effect for each predetermined period from a predicted operating rate of a load facility, as well as display and/or print a value table, a time-series graph and a distribution graph for a range and an average value of a predicted profit for each predetermined period. Thus, the device supply service business entity can evaluate and understand risks and merits in the future in the service provided thereby, whereas the load facility user which wishes the device utilization effect can readily understand risks and merits resulting from the introduction of a device supply system to determine the introduction. Consequently, a contract for device supply service introduction can be supported between the device supply service business entity and load facility user.

### Embodiment 2

Next, description will be made, as Embodiment 2, on a method of carrying out a predicted profit simulation by adding, to Embodiment 1, variation factors other than the operating rate, such as the interest rate, power rate and the like. With the use of this method, it is possible to predict a profit resulting from the introduction of the device supply service in consideration of the variation factors other than the operating rate, which are expected to exert influences, such as future fluctuations in the interest, power rate variation and the like.

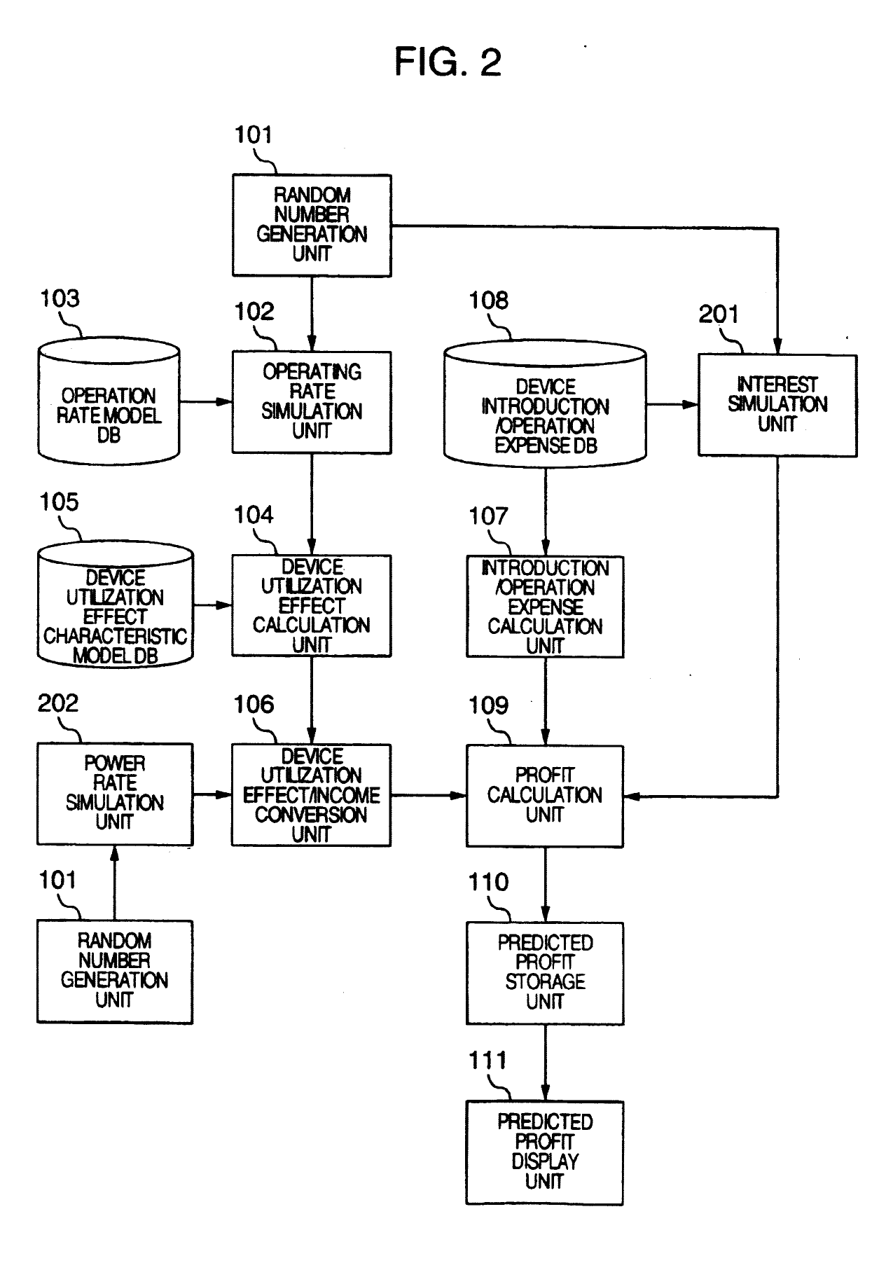

The processing in Embodiment 2 will be described based on a system diagram of FIG. 2. As illustrated in FIG. 2, a system in Embodiment 2 additionally comprises an interest simulation unit 201, and a power rate simulation unit 202 in addition to the system in Embodiment 1 illustrated in FIG. 1. Again, a random number generated by the random number generation unit 101 is utilized herein together with the interest simulation unit 201 and power rate simulation unit 202. Alternatively, a different random number from the operating rate simulation unit 102 may be newly generated for utilization.

The interest simulation unit 201 receives a random number RI(k, i) generated in the random number generation unit 101 to determine an interest I(k, i) in an i-th year in a k-th simulation from a previously set interest fluctuation model and the random number RI(k, i). Here, an interest prediction model may be given as an arbitrary normal distribution model as indicated by Expression (1), or may be an interest fluctuation model created by totalizing actual interest data in the past several years, and building a distribution model, in a manner similar to the operating rate prediction model illustrated in FIG. 17. When the interest is changed, the discount profit Gp(k, i) in each year calculated in the predicted profit calculation unit 109 also changes, and is newly calculated as indicated by Expression (9):

$$Gp ( k , i ) = \frac{G ( k , i )}{{\prod }_{j = 1}^{i} ( 1 + J ( k , j ) )} \qquad ( 9 )$$

The power rate simulation unit 202 receives a random number R2(k, i) generated by the random number generation unit 101 to determine a power rate C(k, i) in the i-th year in the k-th simulation from a previously set power rate fluctuation model and the random number R2(k, i). Here, the power rate fluctuation model may be given as an arbitrary normal distribution model as is the case with the interest fluctuation model, or may be a power rate fluctuation model which is built from a distribution model that totalizes actual power rate data in the past several years as illustrated in FIG. 17. Also, when the power rate is changed, the income IN(k, i) in each year calculated in the device utilization effect/income conversion unit 106 changes as well, and is newly calculated as indicated by Expression (10):

IN(k, i)=C(k, i)×P(k, i) (10)

In this manner, according to Embodiment 2, it is possible to predict the profit in consideration of fluctuation factors other than the operating rate, which affects strongly the profit resulting from the introduction of the device, such as future interest fluctuations, power rate fluctuations and the like, and also evaluate and understand risks and merits resulting from a service to be supplied by displaying and/or printing values, a time-series graph and a distribution graph of the range and average value of the profit.

### Embodiment 3

In continuation, description will be made, as Embodiment 3, on a method of similarly simulating an operating rate for at least two or more device services such as a device purchase and a device lease, and displaying and/or printing values and time-series graphs of ranges and averages of predicted profits for each predetermined period for comparison. With the use of this method, the load facility user can readily determine which device service should be introduced, while the device supply service business entity can present the prepotency of a device supply service provided thereby.

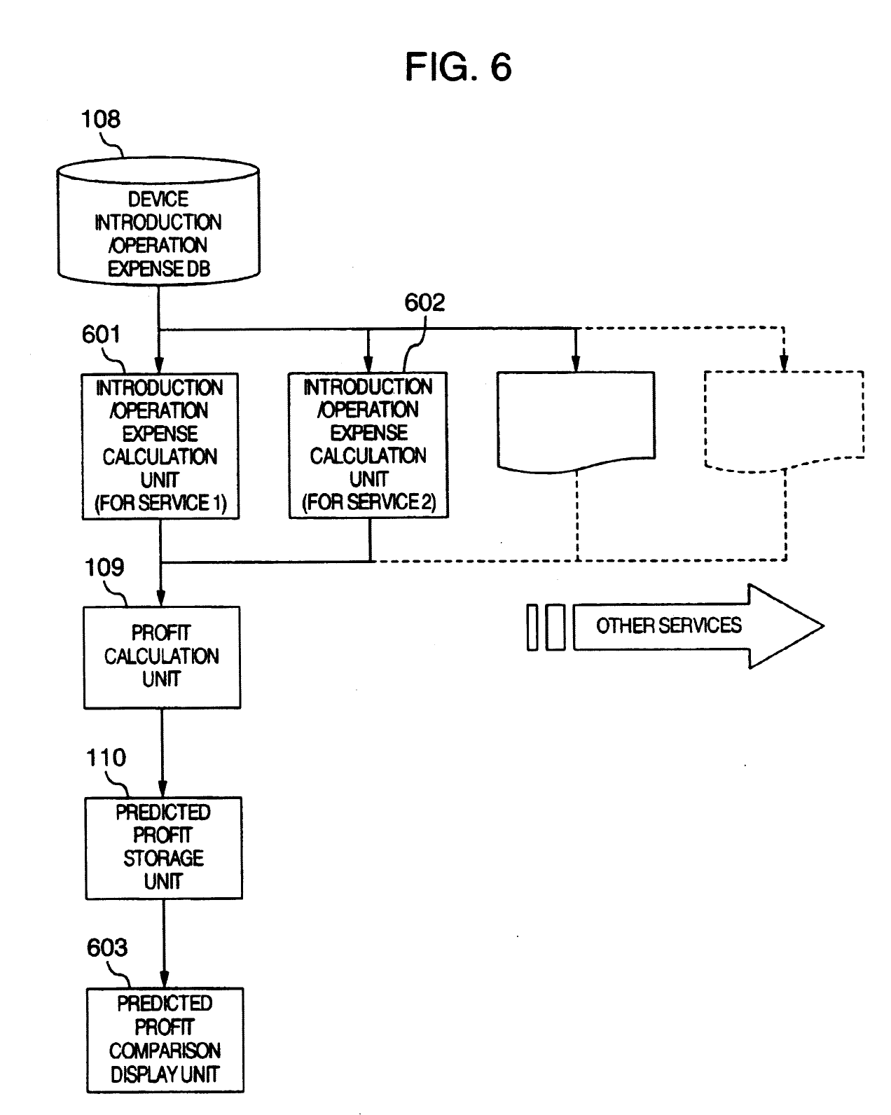

The processing in Embodiment 3 will be described based on FIG. 6.

Embodiment 3 provides a number of the introduction/operation expense calculation units 107 as much as the number of services for comparison as illustrated in FIG. 6, and for example, in FIG. 6, each of an introduction/operation expense calculation unit (for service 1) 601, an introduction/operation expense calculation unit (for service 2) 602, . . . , simulates the profit prediction simulation N times for a plurality of services to be compared with one another.

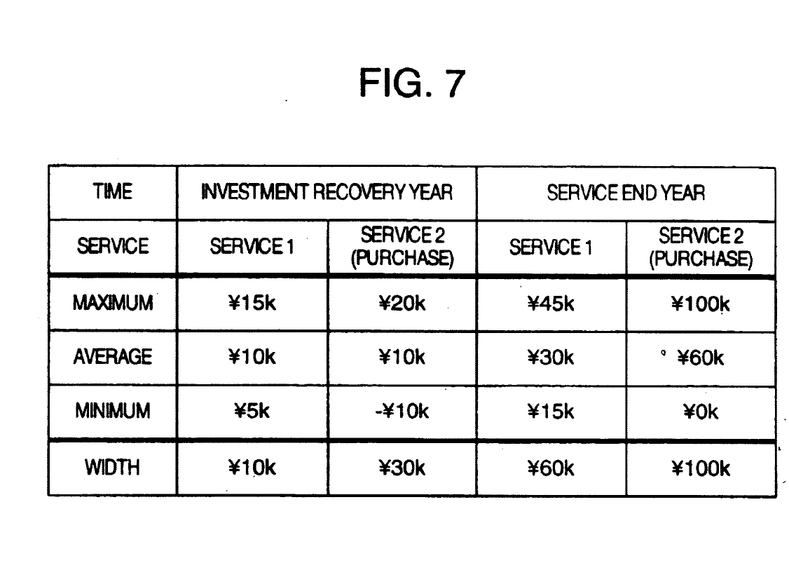

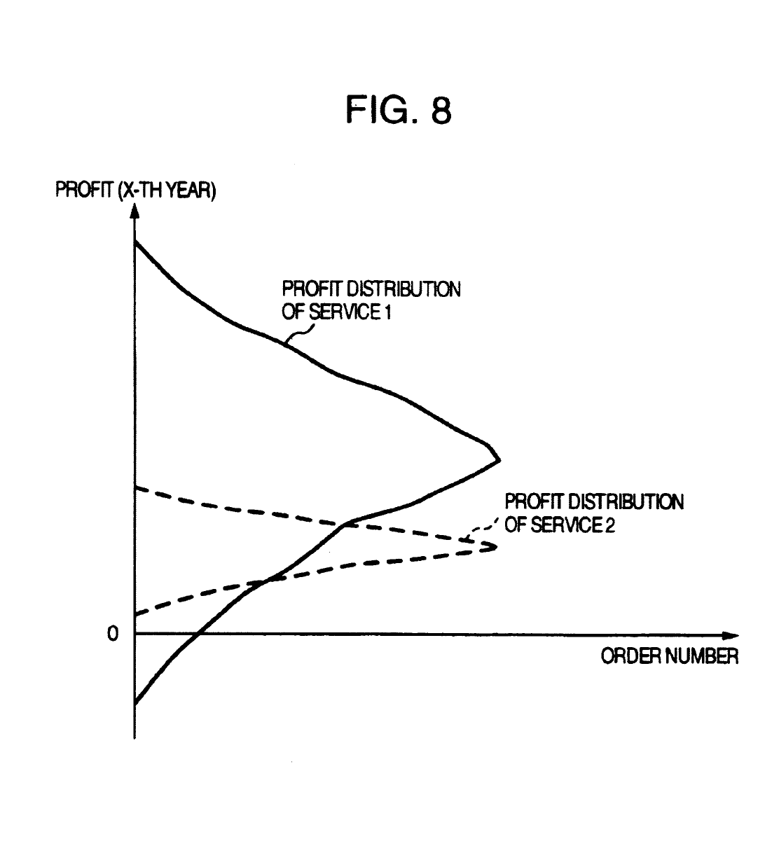

A predicted profit comparison display unit 603 presents for comparison, at least one or more of AGmax(j), a minimum value AGmin(j), a width AGwid(j) and an average value AGavg(j) of a predicted profit in an arbitrary year j, calculated by the profit prediction storage unit 110 for each service, in a manner similar to Embodiment 1 as indicated in FIG. 7. Also, as shown in FIG. 8, the predicted profit comparison display unit 603 displays for comparison distribution graphs of a plurality of services for a predetermined year j on the same graph. Particularly, as each load facility user sets an arbitrary year j, it is possible to specify a limit of years by which a profit must be made appropriate for an investment required to introduce a certain service, such as an investment recovery period. Assuming herein, for example, that there are a service 1 (FIG. 8) which results in a minus predicted minimum profit in investment recovery years, and a service 2 (FIG. 8) which results in a plus minimum profit, the load facility user can readily determine that the service 2 should be introduced from a restriction that the profit must be positive in the investment recovery years even if an expected profit (average value) of the service 1 is larger than an expected profit of the service 2.

In this way, Embodiment 3 permits the load facility user to readily determine which device service should be introduced, while the device supply service business entity can present the prepotency of a device supply service provided thereby, by displaying and/or printing, for comparison, values and a distribution graph of a range, such as an average value for each predetermined period, for a plurality of services.

### Embodiment 4

In continuation, description will be made, as Embodiment 4, on a method of displaying and/or printing values and time-series graphs of a range, such as an average value of a predicted profit in each predetermined period, for the device service business entity and load facility user, using an equivalent operating rate simulation. With the use of this method, the device supply service entity and load facility user can understand how profits and risks are allocated and distributed therebetween. The load facility user can readily validate a device price and a service fee, while the device provision service business entity can present a rational service fee for risks loaded thereon.

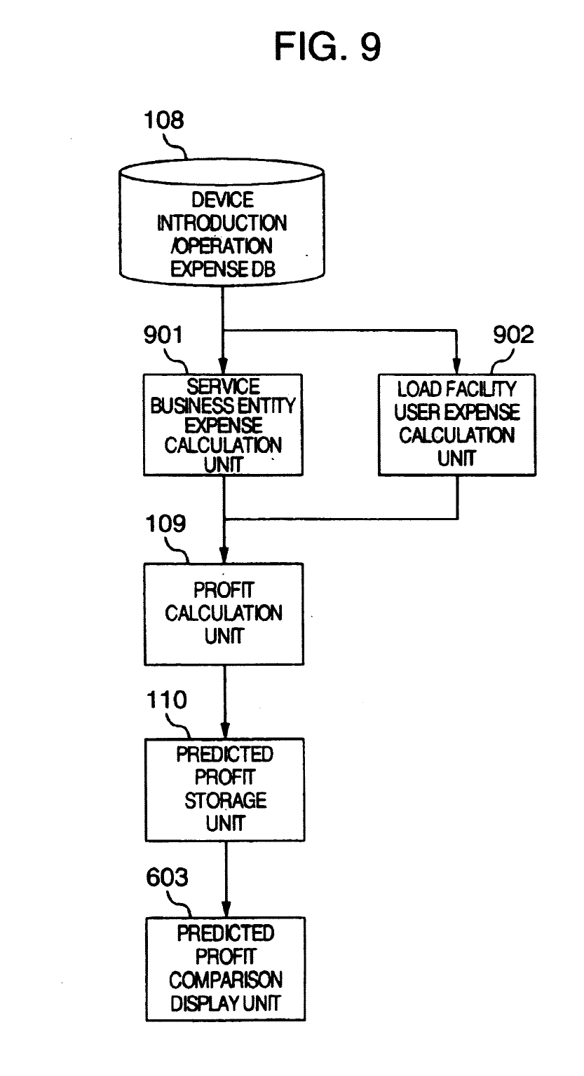

The processing in Embodiment 4 will be described based on FIG. 9.

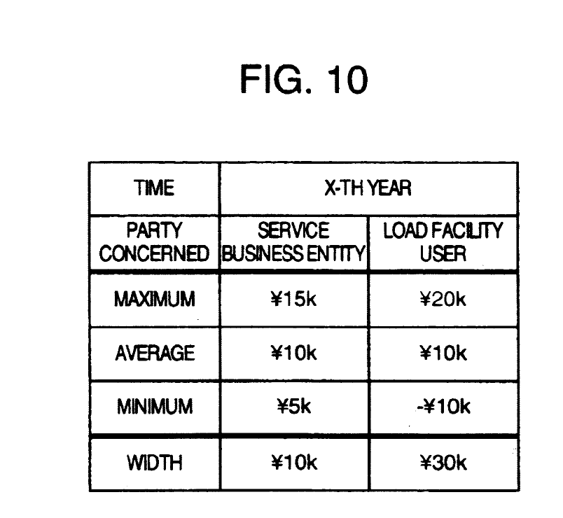

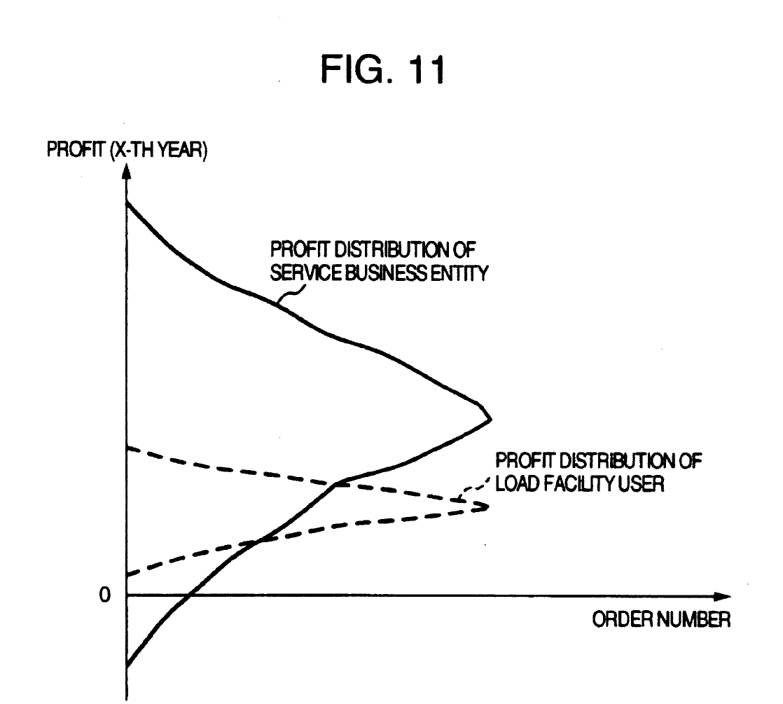

As illustrated in FIG. 9, in Embodiment 4, two introduction/operation expense calculation units 107 in Embodiment 1 are provided, one for a service business entity expense calculation unit 901 and one for a load facility user expense calculation unit 902 for simulating predicted profits of the service business entity and load facility user for an arbitrary service N times. Like Embodiment 3, the predicted profit comparison display unit 603 presents, for comparison, at least one or more of values of AGmax(j), minimum value AGmin(j), width AGwid(j) and average value AGavg(j) of the service business entity and load facility user in an arbitrary year j calculated in the predicted profit storage unit 110, as shown in FIG. 10. Also, as shown in FIG. 11, distribution graphs associated with the service business entity and load facility user for each year j are displayed on the same graph for comparison. Particularly, the difference in the width AGwid(j) between the service business entity and load facility user indicates a distribution of risks between the service supplier and load facility user, where a larger width AGwid(j) permits the service business entity or load facility user to understand that it is burdened with a larger risk associated with an arbitrary service. For example, when the service business entity has a larger expected profit (average value) than the load facility user, the service business entity can determine that it is burdened with a large risk if the service business entity has a larger width than the load facility user or if the minimum value is minus, thereby making it possible to set a service fee in accordance with the risk.

In this way, Embodiment 4 permits the device supply service business entity and load facility user to understand how the profits and risks are shared and distributed therebetween by displaying and/or printing for comparison the values and distribution graph of a range, and the average value of a predicted profit for each predetermined period for the device provision service business entity and load facility user. The load facility user can readily validate the device price and service fee, while the device provision service business entity can present a proper service fee for a risk which is burdened thereon.

### Embodiment 5

In continuation, description will be made, as Embodiment 5, on a method of calculating an upper limit value and a lower limit value for a service fee such that a risk (range) of a predicted profit after a predetermined period falls within an allowable range if either the device supply service business entity or the load facility user sets an allowable amount of risks, which is, for example, a width AGwid(j), and displaying the upper limit value and lower limit value for the service fee on a screen, and a method of displaying, for comparison, profit prediction distribution graphs when the upper limit value and lower limit value are set for the service price and when the upper limit value or the lower limit value is not set.

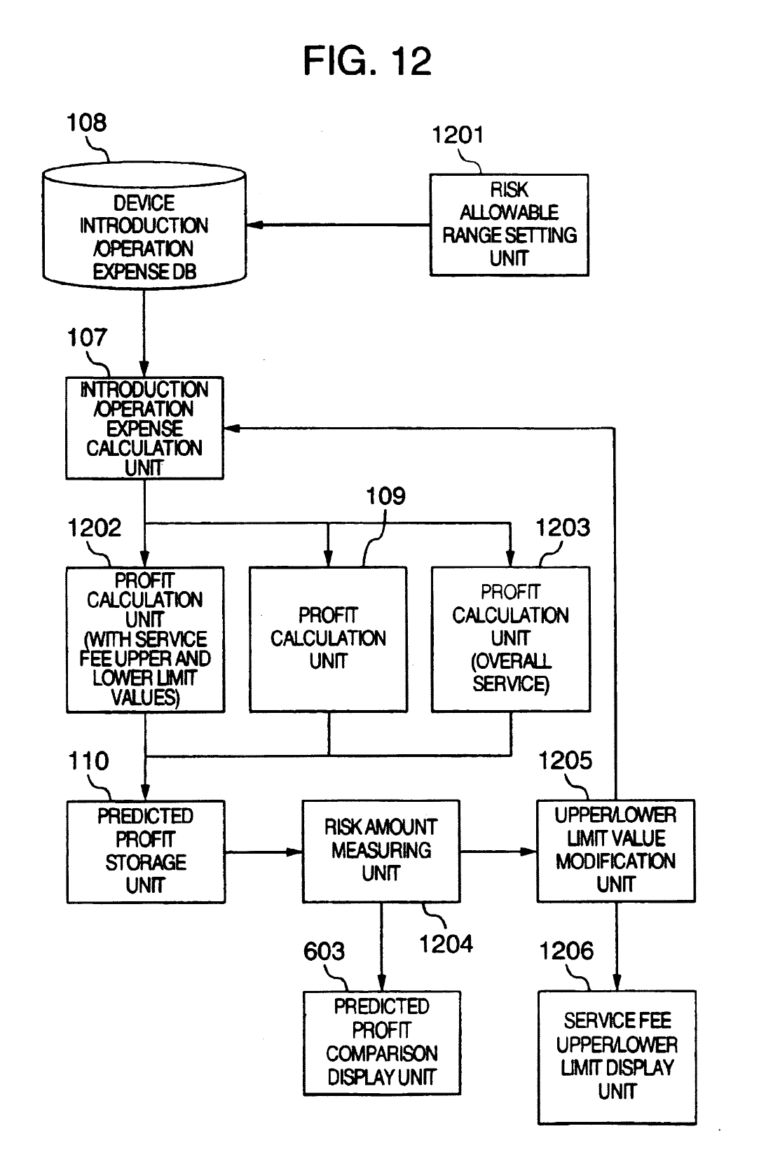

The processing in Embodiment 5 will be described based on a system diagram of FIG. 12.

As illustrated in FIG. 12, Embodiment 5 comprises a risk allowable range setting unit 1201 for the device supply service business entity or load facility user to set an allowable amount for a risk; a profit calculation unit (with service fee upper and lower limit values) 1202 for calculating a predicted profit when the upper limit value and lower limit value are set for a service fee; a profit calculation unit 1203 for calculating a total profit prediction error between the service supply entity and load facility user; a risk amount measuring unit 1204 for calculating the amount (width) of risk when an arbitrary upper limit value and lower limit value are set; an upper and lower limit value modification unit 1205 for modifying the upper limit value and lower limit value when the arbitrary upper limit value and lower limit value fall out of the set allowable range; and a service fee upper and lower limit value display unit 1206 for presenting the upper limit value and lower limit value.

In the risk allowable range setting unit 1201, the device supply service business entity or load facility user sets an allowable range for a risk. Here, the risk allowable range is a ratio Rwid=AGwid′(j)/AGwid(j) when the upper limit value and lower limit value are set for the service fee to a width AGwid(j) of a profit prediction result of an overall energy saving device service to be supplied, and the service business entity or load facility user sets a threshold B such that the ratio Rwid is equal to or less than an arbitrary value B %, Rwid<B %.

As an upper limit value Fupper and a lower limit value Flower are set for an arbitrary service fee, the profit calculation unit (with the service fee upper and lower limit values) 1202 calculates a service utilization fee F′(i, k) actually paid by the load facility user or paid to the service business entity for a service utilization fee F(i, k) calculated in the device utility effect-to-income conversion unit 106 in Embodiment 1, as indicated by Expression (11):

F′(i, k)=max(F_{lower}, min(Fᵤₚₚₑᵣ, F)(i,k)) (11)

A predicted profit is calculated using this new service utilization fee F′(i, k).

The profit calculation unit (overall service) 1203 sums up the predicted profits of the service business entity and load facility user, separately calculated in Embodiment 4, to calculate a total predicted profit, thereby making it possible to understand a profit distribution and width over the overall device supply service and to understand the proportion of the risk (width) of the profit calculated in the profit calculation unit (with service fee upper and lower limit values) to the overall risk (width).

The risk amount measuring unit 1204 calculates a ratio Rwid=AGwid′(j)/AGwid(j) from the width AGwid(j) of the profit prediction result for the overall device supply service calculated in the profit calculation unit (overall service) 1203, and the with AGwid′(j) when the upper limit value and lower limit value have been set for the service price calculated in the profit calculation unit (with the service fee upper and lower limit values) 1202, and compares the Rwid with the threshold B % set in the risk allowable range setting unit 1201 to determine whether or not Rwid<B % is satisfied.

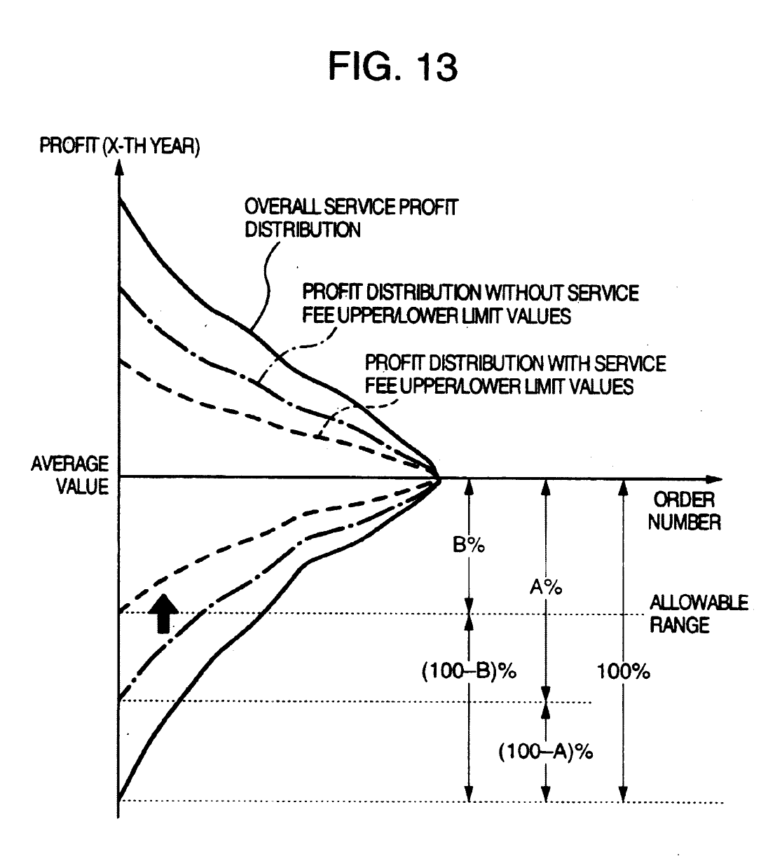

The upper and lower limit value modification unit 1205 modifies the upper limit value Fupper and lower limit value Flower of the service fee when the risk amount measuring unit 1204 determines that Rwid<B % is not satisfied. For example, it is contemplated herein to previously set an amount D1 by which the upper limit value is reduced, and an amount D2 by which the lower limit value is increased, and a new upper limit value Fupper is calculated as Fupper-D1, while a new lower limit value is calculated as Flower=Flower+D2. After modifying the upper and lower limit values, the processing in elements 107 to 1205 is repeated until Rwid<B % is satisfied. Assuming, for example, that the profit distribution of the overall service has a width of 100%, the profit distribution has a width of A % when no upper and lower limit values are set for the service fee, and when B<A, the upper and lower limit values are modified to improve the width of the profit distribution with the service fee upper and lower limit values to B %, as indicated by an arrow in FIG. 13.

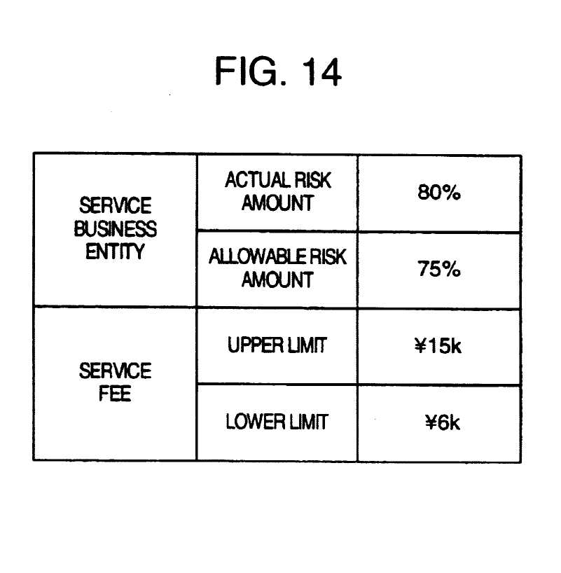

When the risk amount measuring unit 1204 determines that Rwid<B % is satisfied, the service fee upper and lower limit value display unit 1205 presents the upper limit value Fupper and lower limit value. Flower for the service fee at that time, as shown in FIG. 14. Further, as shown in FIG. 14, it is contemplated to simultaneously display the threshold B % indicative of the risk allowable range. It is also contemplated to display the upper limit value Fupper and lower limit value Flower for the service fee at the current time, and a width (risk range) Rwid actually provided by the upper and lower limit values, even if Rwid<B % is not satisfied in the risk amount measuring unit 1204.

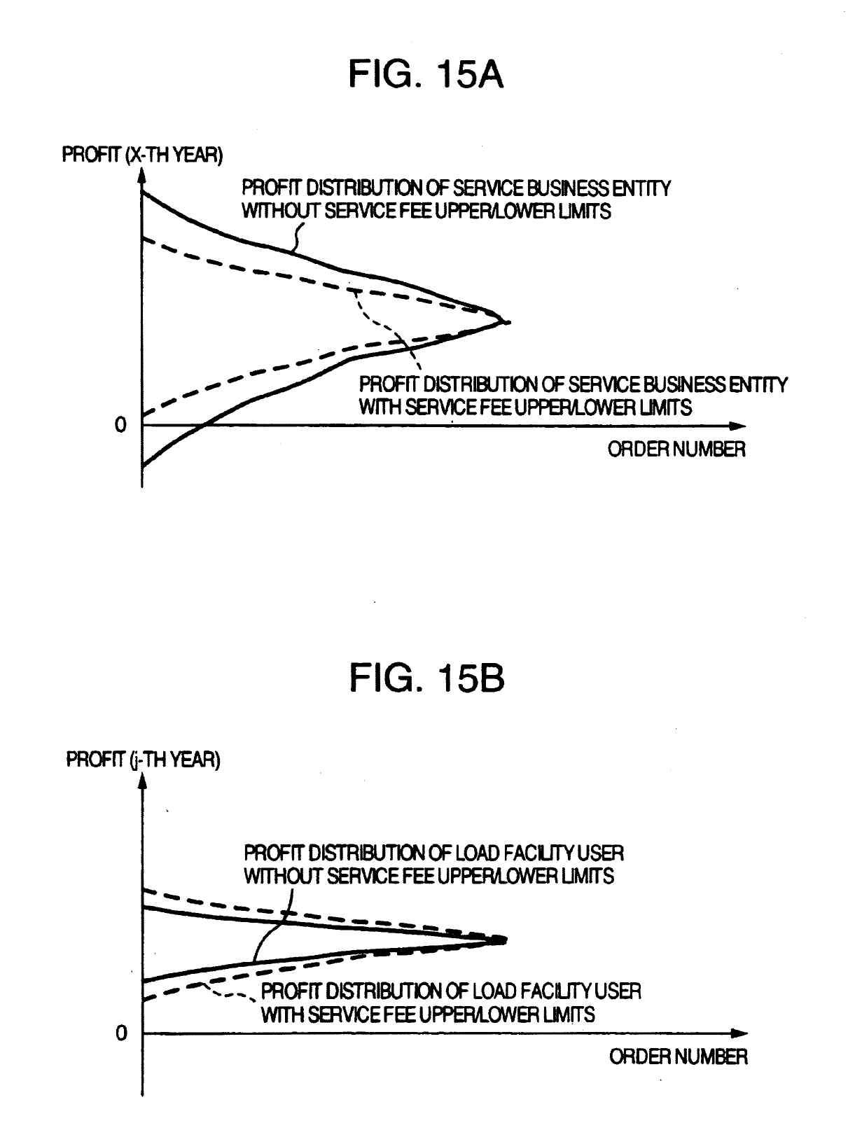

In the predicted profit comparison display unit 603, as shown in FIGS. 15A, 15B, it is contemplated to display two overlapping predicted profit distribution graphs for comparison when the upper and lower limit values are set for the service price and when they are not set. It is also contemplated to specify the risk allowable range by a minimum or a maximum value of the predicted profit, rather than the width.

In this way, by setting an allowable range for a risk, calculating an upper and a lower limit value for defining the allowable range, and presenting the upper and lower limit values as well as presenting a distribution graph for the predicted profit, Embodiment 5 permits the device provision service business entity or load facility user to set a service fee (upper and lower limit values) when it can be burdened with a risk more than its capabilities to avoid the risk. Thus, the allocation and distribution of the profit and risk, which convince both the device supply service business entity and load facility user, is readily realized between the device supply business entity and load facility user.

### Embodiment 6

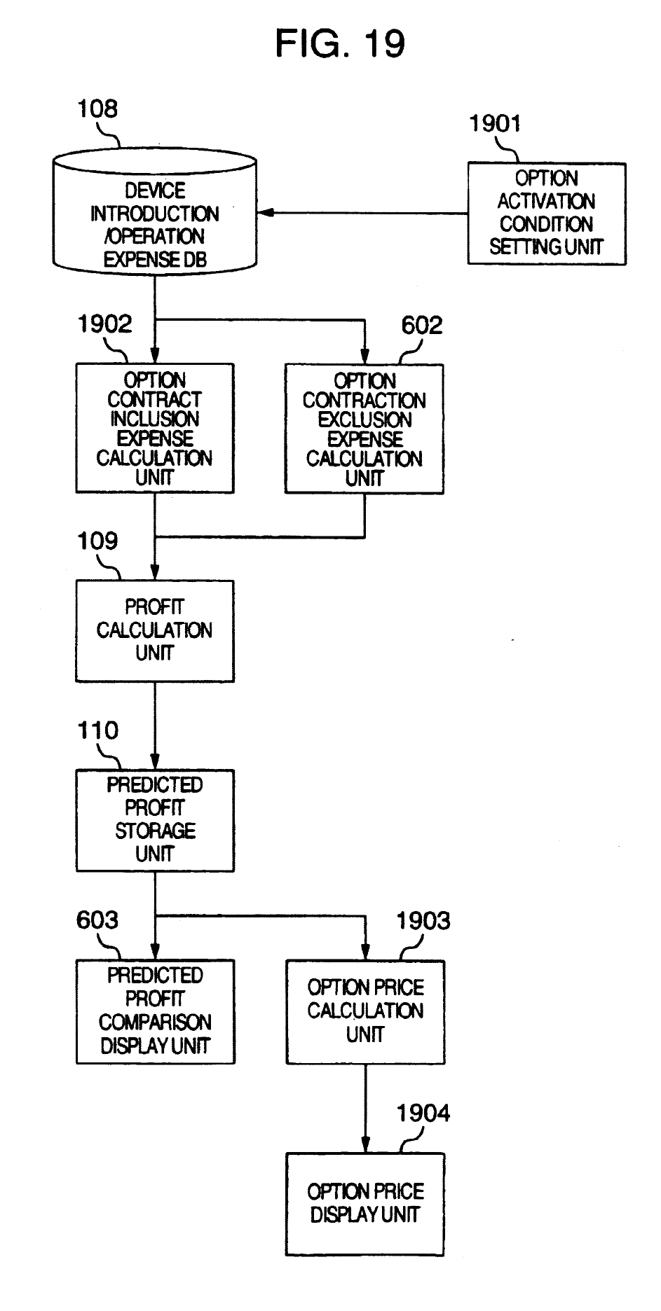

In continuation, description will be made, as Embodiment 6, on a method of calculating a profit for each predetermined period when there are contract clauses such as cancellation of a service or a takeover of a device in the middle of the service, and displaying characteristic values which define profit ranges, and average values, and time-series graphs for comparison when there are the contract clauses and when there are not. In this way, the load facility user can understand the effect when a cancellation clause and a takeover clause are included in the contract for the device provision service to readily determine whether or not such contract clauses should be included upon introduction of the device provision service, while the device supply service business entity can calculate the price of each contract clause for presentation. The processing in Embodiment 6 will be described based on a system diagram of FIG. 19.

As illustrated in FIG. 19, Embodiment 6 comprises an option exertion condition setting unit 1901 for setting an arbitrary contract clause (option) exertion condition; an option contract inclusion expense calculation unit 1902; an option contract exclusion expense calculation unit 602; an expense calculation unit 1903;, and an option price display unit 1904. In this Embodiment 6, the contract clause is assumed to be a cancellation clause for canceling the device supply service in the middle of the service.

The option exertion condition setting unit 1901 sets a condition under which a cancellation clause is activated in the middle of a profit prediction simulation in the profit calculation unit 109. For example, the cancellation clause may be activated under the following conditions: the cancellation is activated in an arbitrary year i, when the sum of the so far accumulated profit AG=ΣG(k, j); j=1 to i and the income IN=I Navg×(Y−i) when an average income INavg={ΣIN(k, j)}/x; j=(i−x) to i has been continued for predetermined years Y is smaller than a predicted expense OUT1=ΣOUT(k, j); j=1 to Y for the predetermined years Y.

The option contract inclusion expense calculation unit 1902 calculates a predicted profit in accordance with the cancellation clause activation condition set in the option exertion condition setting unit 1901. For example, when the cancellation clause is activated here in a j-th year within a profit prediction simulation, the income IN(k, i) resulting from the device utilization effect (energy saving effect) in a (j+1)-th year onward is all zero, and the option contract inclusion expense calculation unit 1902 calculates expenses involved in the operation such as the maintenance device expense Mm(i), maintenance labor cost Mh(i), property tax T(i), device lease expense R(i), and utilization fee F(k, i) to be zero. It is also contemplated that depending on contract conditions, new expenses can be generated such as a cancellation penalty upon activation of the cancellation clause.

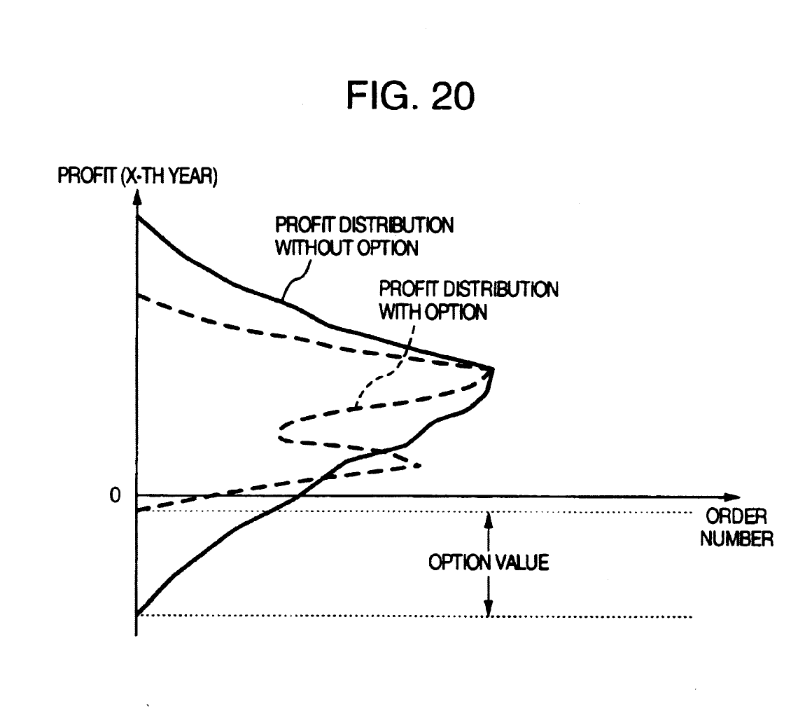

The predicted profit comparison display unit 603 displays for comparison a graph of a profit distribution when a contract clause (option) calculated in the option contract inclusion expense calculation unit 1902 is included as shown in FIG. 20, and a graph of a profit distribution when an option calculated in an option contract exclusion expense calculation unit 602 is not included, and presents for comparison such values as maximum values, minimum values, average values of both distributions. In this way, it is possible to understand the effect produced when the contract clause is added.

The option price calculation unit 1903 calculates the value of an option from a predicted profit when the option is present and a predicted profit when the option is absent. For example, as shown in FIG. 20, it is contemplated herein to calculate the difference between a minimum value of the predicted profit when the option is present and a minimum value of the predicted profit when the option is absent, as an option value OV. The option price may be calculated by multiplying the option value OV by a constant ratio α as OP=α×OV.

The option price display unit 1904 displays and/or prints the option price OP calculated in the option price calculation unit 1903.

In this way, Embodiment 6 can calculate a profit for each predetermined period when there is a contract clause such as a cancellation and a device takeover in the middle of a service, and display for comparison characteristic values which define ranges of profits, average values, and distribution graphs of a contract inclusive case and a contract exclusive case, can calculate an option price from the comparison, and can demonstrate the effect produced when a cancellation clause and a takeover clause are included in the contract. In this way, the load facility user can readily determine whether or not any contract clause should be included upon introduction of a device supply service, while the device supply service business entity can calculate and present the price of each contract clause.

### Embodiment 7

Next, description will be made, as Embodiment 7, a system configuration for implementing the services shown in Embodiment 1 to Embodiment 6, as well as inputs and outputs. In this way, the device supply service business entity can provide a predicted profit resulting from the introduction of a service, a service fee, contract clauses, and an additional fee for the contract clauses (option price) to at least two or more of an indefinite number of load facility users, while the load facility user can understand the effect and profit when a device supply service is introduced into its own load facilities.

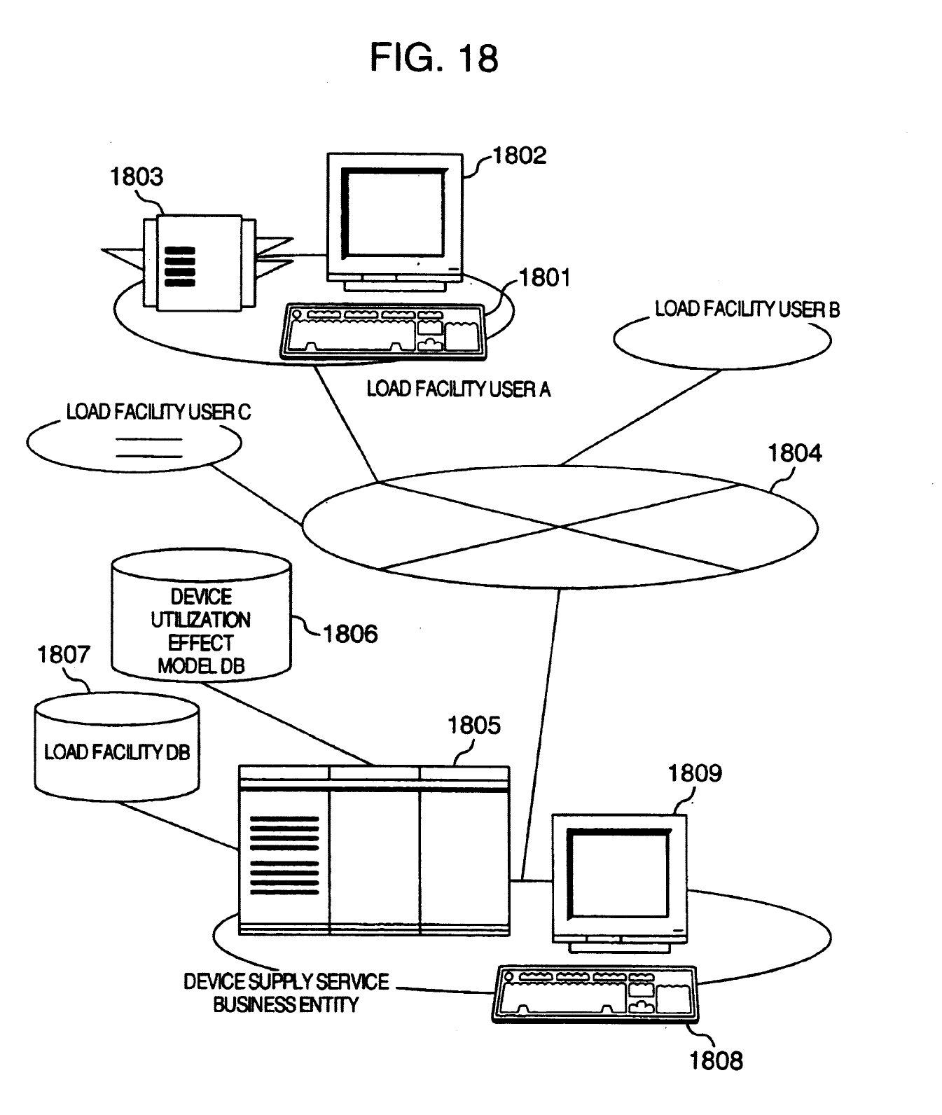

The processing in Embodiment 7 will be described based on a system diagram of FIG. 18.

An arbitrary load facility user comprises an input device 1801 for the load facility user to input information on its own load facilities, desired contract clauses and the like; a display device 1802 for the load facility user to acquire a predicted profit resulting from the introduction of a service, a service fee, contract clauses, an additional fee for the contract clauses, and the like; and a printer 1803 for printing instead of the display on the display device 1802. The device supply service business entity comprises an input device 1808 for the service business entity to input its own service conditions, prices of devices to be supplied, and the like; a display device 1809 for acquiring contents of an order, and an access situation from a load facility user which wishes the introduction of a service; a simulation computer 1805 for calculating a profit resulting from a device utilization effect and a service fee based on load facility information and device selection information from an arbitrary load facility user; a device effect model database (DB) 1806 which stores device utilization effect models for at least one or more devices which can be supplied; a load facility database (DB) 1807 which stores operating rate models for previously supposed load facilities; and a communication medium 1804 for connecting the systems 1801 to 1803 of the load facility user to the systems 1805 to 1809 of the energy saving device service supplier.

The input device 1801 receives a desired device to be introduced selected from the device effect model database (DB) 1806, and receives a load device scheduled to be introduced or a facility similar to this, selected from the load facility database (DB) 1807. Alternatively, when load facility data similar to a possessed load device does not exist in the load facility database (DB) 1807 (even if it does exist), past operating rate result data of the possessed load device may be input such that the simulation computer 1805 builds an operating rate model for the load device from the data for simulation.

The simulation computer 1805 simulates a predicted profit for a predetermined number of years which is generated when a selected device is introduced into a specified load facility, based on the device information, load device information and load device operating rate data inputted from the input device 1801. Further, here, when the past result data of the load device is received to build an operating rate model for the load device from the data, the built model may be additionally stored in the load facility DB 1807.

The display device 1802 displays values and graphs of a profit prediction result calculated in the simulation computer 1805, which are printed by the printer 1803 if necessary. When the load facility user wishes the introduction of a service to be supplied, after confirming the result of the simulation, the load facility user inputs contract acceptance information from the input device 1801, causing the display device 1809 to display the contract acceptance information which is confirmed by the device supply service business entity. When the load facility user which has sent the information agrees to the introduction of a device into its load device, the load facility user inputs contract conclusion information from the input device 1808, and the display device 1802 displays the contract conclusion information, thereby concluding a device supply service contract between the load facility user and device supply service business entity.

Further, here, any of the service business entity and load facility user inputs risk allowable range information from the input device 1808 or input device 1801, the simulation calculation unit 1805 responsively calculates an upper limit value and a lower limit value of the service fee, and the display device 1802 and display device 1809 display the upper limit value and lower limit value, or display a distribution graph of a predicted profit when there are the upper limit value and lower limit value. Furthermore, when the load facility user selects an arbitrary contract clause, for example, a cancellation option for canceling the service, and inputs conditions for activating the option from the input device 1801, the simulation calculation unit 1805 simulates a predicted profit in consideration of the contract clause, and the display device 1802 displays for comparison predicted profits when the contract clause is added and when it is not added. Alternatively, the service business entity has previously inputted arbitrary cancellation clause activation conditions from the input device 1808, the simulation control unit 1805 calculates an option price for the contract condition from the difference between the predicted profits when the contract clause is added and when it is not added, and the display device 1802 displays the option price. The load facility user confirms the result of the simulation and the option price when the contract clause is added, and inputs contract clause addition request information from the input device 1801 when it wishes the addition of the provided contract clause, causing the display device 1809 to display the contract clause addition request information which is confirmed by the device supply service business entity. When the load facility user which has sent the information agrees to the addition of the contract clause to that device service for its load facility, the load facility user inputs contract conclusion information from the input device 1808, and the display device 1802 displays the contract conclusion information, thereby concluding the device supply service contract with the additional contract clause between the load facility user and device supply service business entity

Also, here, the communication medium 1804 for connecting the systems 1801 to 1803 of the load facility user to the systems 1805 to 1809 of the device supply service business entity may be a global network such as the Internet, or may be a local network connected through a dedicated line. Alternatively, the load facility user information may be directly inputted by the device supply service business entity without the intervention of the communication medium 1804, and the result of a simulation alone may be presented to the load facility user.

In this way, with Embodiment 7, the device supply service business entity can present the effect of a device service to be supplied to at least two or more of an indefinite number of load facility users, while the load facility user can determine the introduction of the service after confirming the effect produced by introducing the supply service into a load facility possessed thereby. Furthermore, an operating rate simulation accuracy can be improved for a similar load facility by building an operating rate model from operation data of a load facility and reusing the operating rate model.

According to the present invention, the device supply service business entity can evaluate and understand risks and merits of a service to be supplied in the future, while the load facility user (the party which receives the service) can readily determine the introduction of the service by understanding the risks and merits in the future. It is therefore possible to support a contract for the introduction of a device supply service between the device supply service business entity and load facility user.

While the foregoing description has been made in connection with the embodiments, it should be apparent to those skilled in the art that the present invention is not limited thereto but a variety of alterations and modifications can be made without departing from the spirit of the invention and the scope of appended claims.

What is claimed is:

1. A method of evaluating a service to be supplied, comprising the steps of;
selecting a device to be introduced;
setting a facility into which the device is introduced;
selecting a model for predicting an operating condition of the facility;
calculating a range or a distribution of an expected device utilization effect for each predetermined time from the predicted operating rate value;
converting the utilization effect to an amount of money to calculate an income for each predetermined time;
calculating an expense and income associated with the introduction and operation of the device supply service;
calculating a profit for each predetermined time from the income and the expense; and
presenting characteristic values which define a range of the profit for each predetermined time and an average value or a time-series graph.

2. A method of evaluating a service to be supplied according to claim 1, further comprising the steps of:
specifying an arbitrary time; and
presenting a distribution graph for a profit for the specified time, or presenting characteristic values which define a range of the profit for the specified time.

3. A method of evaluating a service to be supplied according to claim 1, further comprising the steps of:
calculating profits for two or more device supply services; and
presenting for comparison characteristic values which define ranges of profits for the two or more services, and average values, or time-series graphs, or presenting distribution graphs for the profits for each predetermined time.

4. A method of evaluating a service to be supplied according to claim 1, further comprising the steps of:
inputting past operation data for the facility into which the device is introduced; and
building a model for predicting an operating condition from the data.

5. A method of evaluating a service to be supplied according to claim 1, further comprising the steps of:
setting allowable values for the characteristic values which define the range of the profit;
calculating a range of an energy saving device service fee in which the characteristic values which define the range of the profit by the service fall within the allowable values; and
presenting the range of the service fee.

6. A method of evaluating a service to be supplied according to claim 1, further comprising any one or more of the steps of:
setting a cancellation condition for canceling the service in the middle;
calculating a profit by the service when cancellation can be permitted in accordance with the cancellation condition; and
presenting characteristic values which define ranges of profits when the cancellation condition is included and when the cancellation condition is not included, average values, or time-series graphs, or presenting distribution graphs for each time.

7. A method of evaluating a service to be supplied according to claim 1, further comprising the steps of:
presenting a takeover price for each time when the device to be supplied is taken over in the middle of the service; and
modifying the takeover price of the energy saving device for each time from energy saving result data after the supply of the service.

8. A method of evaluating a service to be supplied according to claim 1, further comprising the steps of:
calculating a price for purchasing a right for canceling the service in the middle, or a price for purchasing a right for taking over the energy saving device in the middle of the service; and
presenting the price.

9. A method of evaluating a service to be supplied according to claim 1, wherein the device to be supplied is an energy saving device, and the device utilization effect is an energy saving effect.

10. A system for evaluating a service to be supplied, comprising:
means for selecting a device to be introduced;
means for setting a facility into which the device is introduced;
means for selecting a model for predicting an operating condition of the facility;
means for calculating a range or a distribution of an expected device utilization effect for each predetermined time from the predicted operating rate value;
means for converting the utilization effect to an amount of money to calculate an income for each predetermined time;
means for calculating an expense and income associated with the introduction and operation of the device supply service;
means for calculating a profit for each predetermined time from the income and the expense; and
means for presenting characteristic values which define a range of the profit for each predetermined time and an average value or a time-series graph.

11. A system for evaluating a service to be supplied according to claim 10, further comprising:
means for specifying an arbitrary time; and
means for presenting a distribution graph for a profit for the specified time, or presenting characteristic values which define a range of the profit for the specified time.

12. A system for evaluating a service to be supplied according to claim 10, further comprising:
means for calculating profits for two or more device supply services; and
means for presenting for comparison characteristic values which define ranges of profits for the two or more services, and average values, or time-series graphs, or means for presenting distribution graphs for the profits for each predetermined time.

13. A system for evaluating a service to be supplied according to claim 10, further comprising:
means for inputting past operation data for the facility into which the device is introduced; and
means for building a model for predicting an operating condition from the data.

14. A system for evaluating a service to be supplied according to claim 10, further comprising:
means for setting allowable values for the characteristic values which define the range of the profit;
means for calculating a range of an energy saving device service fee in which the characteristic values which define the range of the profit by the service fall within the allowable values; and
means for presenting the range of the service fee.

15. A system for evaluating a service to be supplied according to claim 10, further comprising any one or more of:
means for setting a cancellation condition for canceling the service in the middle;
means for calculating a profit by the service when cancellation can be permitted in accordance with the cancellation condition; and
means for presenting characteristic values which define ranges of profits when the cancellation condition is included and when the cancellation condition is not included, average values, or time-series graphs, or means for presenting distribution graphs for each time.

16. A system for evaluating a service to be supplied according to claim 10, further comprising:
means for presenting a takeover price for each time when the device to be supplied is taken over in the middle of the service; and
means for modifying the takeover price of the energy saving device for each time from energy saving result data after the supply of the service.

17. A system for evaluating a service to be supplied according to claim 10, further comprising:
means for calculating a price for purchasing a right for canceling the service in the middle, or a price for purchasing a right for taking over the energy saving device in the middle of the service; and
means for presenting the price.
